(19) United States
(12) Patent Application Publication
(10) Pub. No.: US 2015/0139722 A1
(43) Pub. Date: May 21, 2015

(54) SOCKET ATTACHMENT STRUCTURE AND SPRING MEMBER

(71) Applicant: NHK Spring Co., Ltd., Yokohamas-shi (JP)

(72) Inventors: Yoshio Yamada, Nagano (JP); Kohei Hironaka, Nagano (JP); Yusman Sugianto, Singapore (SG); Chee Ping B. Loh, Singapore (SG); Choon Joo S. Yeow, Singapore (SG); Teck H. Wong, Johor Baru (SG); Xiaojun T. Wang, Singapore (SG)

(73) Assignee: NHK SPRING CO., LTD., Yokohama-shi (JP)

(21) Appl. No.: 14/402,929

(22) PCT Filed: Mar. 4, 2013
(86) PCT No.: PCT/JP2013/055888

§ 371 Date: Nov. 21, 2014

Related U.S. Application Data
(60) Provisional application No. 61/649,950, filed on May 22, 2012.

(51) Int. Cl. H01R 12/51; H01R 33/76; H01R 13/46

(52) U.S. Cl. CPC H01R 12/51; H01R 13/46; H01R 33/76
USPC 403/327; 267/158

(57) ABSTRACT

A socket attachment structure for attaching a socket to a substrate, the socket including a plurality of contact probes that respectively contact the substrate and a contacted body at both longitudinal direction ends thereof, a probe holder that accommodates and holds therein the plurality of contact probes according to a predetermined pattern, and a holder member provided around the probe holder, includes: a plurality of support members that extend out from a principal plane of the substrate and are respectively inserted through insertion holes provided in the holder member; and a spring member that is attached to the plurality of support members in a state of biasing the holder member placed on the substrate towards the substrate.

### FIELD

The present invention relates to a socket attachment structure for a test socket used in a continuity state test or an operation characteristic test on a test target, such as a semiconductor integrated circuit or a liquid crystal panel, and to a spring member used in this socket attachment structure.

### BACKGROUND

Conventionally, when a continuity state test or an operation characteristic test on a test target, such as a semiconductor integrated circuit or a liquid crystal panel, is performed, a test socket (hereinafter, referred to as “socket”), accommodating therein a plurality of contact probes, is used, in order to electrically connect between the test target and a signal processing device having a circuit board that outputs a test signal. Along with recent development of high integration and refinement of semiconductor integrated circuits and liquid crystal panels, techniques for sockets have developed, which are applicable to test targets that are more highly integrated and more refined, by narrowing the pitch of the contact probes.

A conventional socket has a plurality of contact probes, a probe holder that accommodates and holds therein the plurality of contact probes according to a predetermined pattern, and a holder member that is provided around this probe holder and suppresses displacement of a semiconductor integrated circuit, which comes into contact with the plurality of contact probes when tested. The socket is fixed by the holder member being screwed onto a circuit board of a signal processing device, to maintain an electrically connected state therebetween (for example, see Patent Literature 1).

### CITATION LIST

### Patent Literature

Patent Literature 1: Japanese Patent Application Laid-open No. 2010-003511

### SUMMARY

### Technical Problem

Sometimes, a plurality of circuit boards are provided in a signal processing device, correspondingly with a plurality of semiconductor integrated circuits. In that case, there is a need to respectively attach the sockets mentioned above to the signal processing device (onto the circuit boards) correspondingly with the respective semiconductor integrated circuits. Because each socket needs to be screwed thereon, that work may take a long period of time. Further, this work requires a lot of labor, and similar problems may be caused when the sockets are removed from the signal processing device (circuit boards). Accordingly, a technique for simplifying detachment and attachment between a socket and a circuit board has been desired.

The present invention has been made in view of the above, and an object thereof is to provide a socket attachment structure and a spring member that enable simple detachment and attachment between a socket and a circuit board.

### Solution to Problem

To solve the above-described problem and achieve the object, a socket attachment structure according to the present invention attaches a socket to a substrate, the socket including a plurality of contact probes that respectively contact the substrate and a contacted body at both longitudinal direction ends thereof, a probe holder that accommodates and holds therein the plurality of contact probes according to a predetermined pattern, and a holder member provided around the probe holder. The socket attachment structure includes: a plurality of support members that extend out from a principal plane of the substrate and are respectively inserted through insertion holes provided in the holder member; and a spring member that is attached to the plurality of support members in a state of biasing the holder member placed on the substrate towards the substrate.

Moreover, in the socket attachment structure according to the present invention, the spring member is a plate spring, has a base portion that is approximately belt shaped, and two arm portions that extend from both longitudinal direction ends of the base portion on a plane that a plate surface passes, in a direction approximately perpendicular to a longitudinal direction of the base portion, and forms an approximate C-shape in a planar view seen from a direction vertical to the plate surface, and the arm portion includes: a bending portion that is provided at a distal end side and bends with respect to the plate surface; and a first through hole that penetrates in a plate thickness direction and through which the support member is insertable.

Moreover, in the socket attachment structure according to the present invention, the support member has a reduced diameter at a side surface at a distal end side thereof, the first through hole includes: a first hole portion that forms an inner space having a diameter larger than a largest diameter of the support member and that is approximately column shaped; and a second hole portion that extends to a side different from a distal end side with a width less than the diameter of the first hole portion and larger than a portion of the support member with the reduced diameter, and after the support members are inserted through the first hole portions, the plate spring is slid with respect to the substrate and the second hole portions are latched onto the support members.

Moreover, in the socket attachment structure according to the present invention, the holder member includes a screw hole that is screwable, the arm portion includes a second through hole penetrating in the plate thickness direction correspondingly with the screw hole, and the holder member and the spring member are coupled to each other via the screw hole and the second through hole.

Moreover, in the socket attachment structure according to the present invention, the holder member includes: a protruded portion that protrudes from a principal plane in an approximate column shape and comes into contact with a part of the arm portion; and a claw portion that protrudes from a part of a side surface of the protruded portion, and the holder member and the spring member are fixed to each other by the arm portion being latched onto the claw portion.

Moreover, in the socket attachment structure according to the present invention, the spring member is a plurality of bar shaped members that are elastically deformable, the spring member includes: a base portion that is approximately bar shaped; and a convex portion that is provided at one end side of the base portion and curved in a convex shape, and the convex portion is latched onto one of the support members and the other end side of the base portion is coupled to another one of the support members.

Moreover, in the socket attachment structure according to the present invention, one end side of the base portion is wound around the support member and the spring member is rotatable about the support member being a central axis.

Moreover, in the socket attachment structure according to the present invention, the holder member includes two notched portions that are respectively provided at opposite outer edge sides on a top surface side thereof and that are notched along these outer edges, and the holder member guides an attachment position of the spring member with respect to the holder member.

Moreover, a spring member according to the present invention is used in order to attach a socket to a substrate, the socket including: a plurality of contact probes that respectively contact the substrate and a contacted body at both longitudinal direction ends thereof; a probe holder that accommodates and holds therein the plurality of contact probes according to a predetermined pattern; and a holder member provided around the probe holder, and the spring member is attached to a plurality of support members in a state of biasing the holder member placed on the substrate towards the substrate, the plurality of support members extending out from a principal plane of the substrate, and the plurality of support members being respectively inserted through insertion holes provided in the holder member.

### Advantageous Effects of Invention

According to the present invention, since a socket is attached to one of substrates by just attaching a spring member to a support member in a state where a load is applied on a holder member towards the substrate, an effect of being able to perform simple detachment and attachment of the socket from and to the substrate is achieved.

### BRIEF DESCRIPTION OF DRAWINGS

FIG. 1 is a perspective diagram illustrating a schematic configuration of a socket attachment structure according to a first embodiment of the present invention.

FIG. 2 is a partial cross section diagram illustrating a configuration of main parts of a socket according to the first embodiment of the present invention.

FIG. 3 is a partial cross section diagram illustrating a configuration of main parts of the socket upon testing of a semiconductor integrated circuit according to the first embodiment of the present invention.

FIG. 4 is a perspective diagram illustrating a configuration of main parts of the socket according to the first embodiment of the present invention.

FIG. 5 is a perspective diagram illustrating a configuration of main parts of the socket attachment structure according to the first embodiment of the present invention.

FIG. 6 is a perspective diagram illustrating a configuration of main parts of the socket attachment structure according to the first embodiment of the present invention.

FIG. 7 is a perspective diagram illustrating a configuration of main parts of the socket according to the first embodiment of the present invention.

FIG. 8 is a perspective diagram illustrating a configuration of main parts of the socket according to the first embodiment of the present invention.

FIG. 9 is a perspective diagram illustrating a configuration of main parts of the socket according to the first embodiment of the present invention.

FIG. 10 is a perspective diagram illustrating a configuration of main parts of a socket according to a second embodiment of the present invention.

FIG. 11 is a perspective diagram illustrating a configuration of main parts of a socket attachment structure according to the second embodiment of the present invention.

FIG. 12 is a perspective diagram illustrating a configuration of main parts of the socket attachment structure according to the second embodiment of the present invention.

FIG. 13 is a perspective diagram illustrating a configuration of main parts of a socket according to a third embodiment of the present invention.

FIG. 14 is an exploded perspective diagram illustrating a configuration of main parts of the socket according to the third embodiment of the present invention.

FIG. 15 is a plan view illustrating a configuration of main parts of a socket attachment structure according to the third embodiment of the present invention.

FIG. 16 is a perspective diagram illustrating a configuration of main parts of the socket according to the third embodiment of the present invention.

FIG. 17 is a perspective diagram illustrating a configuration of main parts of the socket according to the third embodiment of the present invention.

### DESCRIPTION OF EMBODIMENTS

Hereinafter, modes for carrying out the present invention will be described in detail, together with the drawings. The present invention is not limited by the following embodiments. Further, each drawing referred to in the following description schematically illustrates shapes, sizes, and positional relations merely to an extent that allows contents of the present invention to be understood. That is, the present invention is not limited only to the shapes, sizes, and positional relations exemplified in each drawing.

### First Embodiment

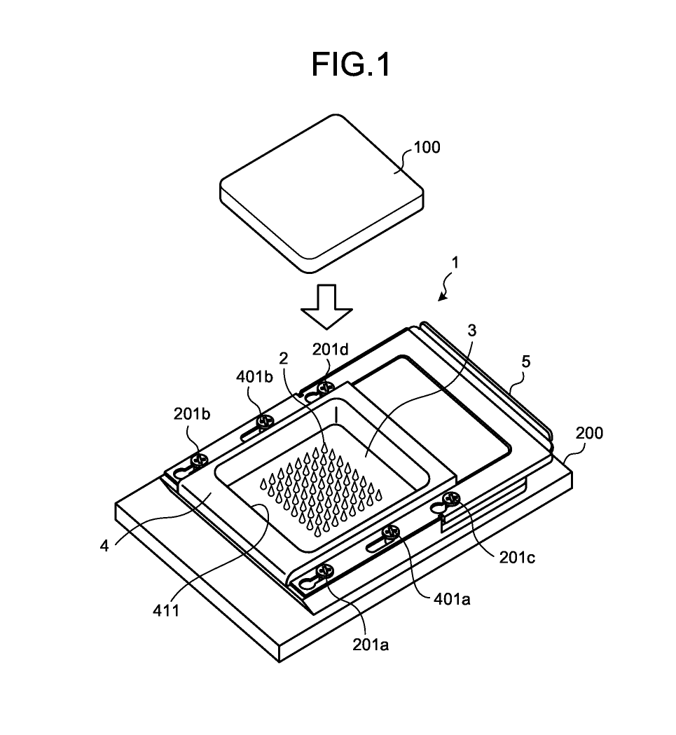

FIG. 1 is a perspective diagram illustrating a schematic configuration of a socket attachment structure according to a first embodiment of the present invention. A socket 1 illustrated in FIG. 1 is a device used in testing electrical properties of a semiconductor integrated circuit 100, which is a target to be tested, and is a device that electrically connects between the semiconductor integrated circuit 100 and a circuit board 200, which outputs a test signal to the semiconductor integrated circuit 100.

The socket 1 has: a plurality of contact probes 2 (hereinafter, simply referred to as “probes 2”), each of which contacts one electrode (contacted body) of the semiconductor integrated circuit 100 that is a contacted body at one of longitudinal direction end sides thereof, and which respectively contact different electrodes of the circuit board 200 at the other end side thereof; a probe holder 3, which accommodates and holds therein the plurality of probes 2 according to a predetermined pattern; a holder member 4, which suppresses displacement of the semiconductor integrated circuit 100 that comes into contact with the plurality of probes 2 when tested; and a plate spring 5 (spring member), which is attached to a top surface of the holder member 4 and biases the holder member 4 towards the circuit board 200.

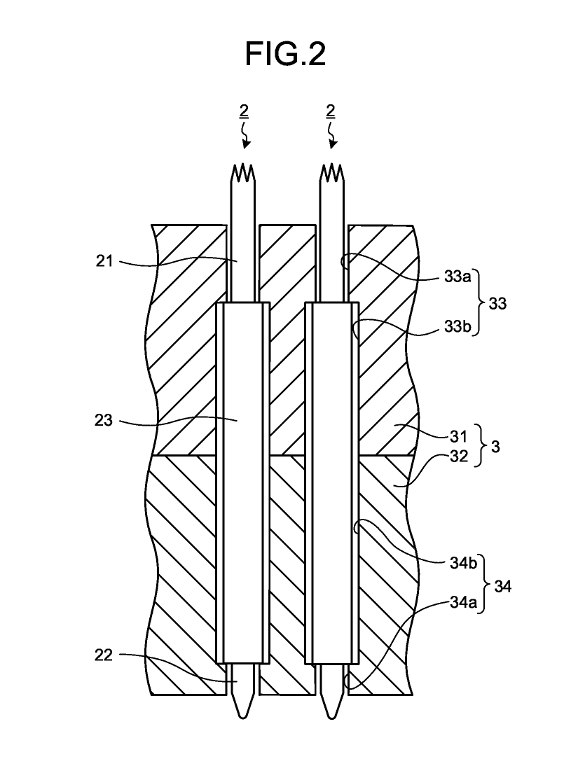

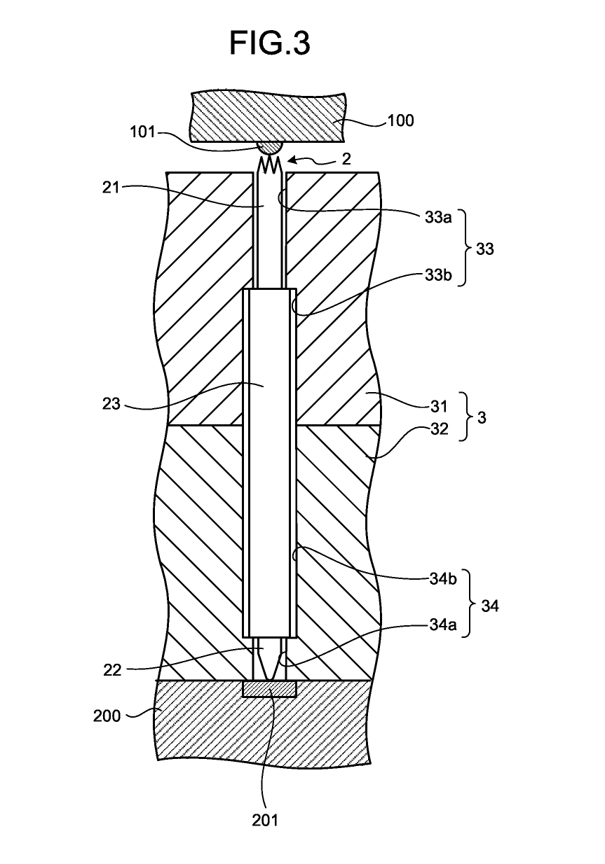

FIG. 2 is a diagram illustrating a configuration of the probes 2 accommodated in the probe holder 3. The probe 2 illustrated in FIG. 2 includes: a first plunger 21, which contacts the connection electrode of the semiconductor integrated circuit 100 when the semiconductor integrated circuit 100 is tested; a second plunger 22, which contacts an electrode of the circuit board 200 including a test circuit; and a pipe member 23, which covers an outer periphery of a spring member (not illustrated) interposed between the first plunger 21 and second plunger 22. The first plunger 21 and second plunger 22, and the pipe member 23, which form the probe 2, have the same axis line. When the semiconductor integrated circuit 100 is contacted with the probe 2, by the spring member inside the pipe member 23 expanding and contracting in a direction of the axis line, impact on the connection electrode of the semiconductor integrated circuit 100 is relieved and a load is applied to the semiconductor integrated circuit 100 and the circuit board 200. Since the first plunger 21 comes into contact with, for example, a hemispherical connection electrode 101 (see FIG. 3) of the semiconductor integrated circuit 100, the first plunger 21 has a plurality of sharp end portions having tapered end shapes.

The probe holder 3 is formed by using an insulating material, such as a resin, a machinable ceramic, or a silicone, and is formed of a first member 31 positioned on a top surface side of FIG. 2 and a second member 32 positioned on a bottom surface side of FIG. 2, which are layered over each other. The first member 31 and second member 32 respectively have the same number of holder holes 33 and 34 formed therein for accommodating the plurality of probes 2, and the holder holes 33 and 34 that accommodate the probe 2 are formed such that their axis lines are aligned with each other. Positions at which the holder holes 33 and 34 are formed are determined according to a wiring pattern of the semiconductor integrated circuit 100.

The holder holes 33 and 34 both form a stepped hole shape having different diameters along a penetrating direction thereof. That is, the holder hole 33 is formed of a small diameter portion 33a having an opening at an upper end surface of the probe holder 3 and a large diameter portion 33b having a diameter larger than that of this small diameter portion 33a. The diameter of the small diameter portion 33a is slightly larger than a diameter of the first plunger 21. Further, the diameter of the large diameter portion 33b is slightly larger than a diameter of the pipe member 23.

The holder hole 34 is formed of a small diameter portion 34a having an opening on a bottom end surface of the probe holder 3 and a large diameter portion 34b having a diameter larger than that of this small diameter portion 34a. The diameter of the small diameter portion 34a is slightly larger than a diameter of the second plunger 22. Further, the diameter of the large diameter portion 34b is slightly larger than the diameter of the pipe member 23. Shapes of these holder holes 33 and 34 are determined according to a configuration of the probe 2 accommodated therein.

The pipe member 23 has a function of stopping the probe 2 from coming out of the probe holder 3 by abutting on a boundary wall surface between the small diameter portion 33a and large diameter portion 33b of the holder hole 33. Further, the pipe member 23 has a function of stopping the probe 2 from coming out of the probe holder 3 by abutting on a boundary wall surface between the small diameter portion 34a and large diameter portion 34b of the holder hole 34. As long as each of the first and second plungers protrudes from the probe holder 3, an applicable length of the pipe member 23 in a longitudinal direction thereof is equal to or less than a length of the large diameter portion 33b and large diameter portion 34b communicated with each other.

FIG. 3 is a diagram illustrating a state upon testing of the semiconductor integrated circuit 100 by using the probe holder 3. When the semiconductor integrated circuit 100 is tested, by a contact load from the semiconductor integrated circuit 100, the spring member inside the pipe member 23 is brought into a state of being compressed along a longitudinal direction thereof. Along with this compression of the spring member, the first plunger 21 advances into the pipe member 23. The test signal supplied to the semiconductor integrated circuit 100 from the circuit board 200 upon the testing reaches the connection electrode 101 of the semiconductor integrated circuit 100 via the probe 2 from each electrode 201 of the circuit board 200. Specifically, in the probe 2, the test signal reaches the connection electrode 101 of the semiconductor integrated circuit 100 via the second plunger 22, the spring member inside the pipe member 23, and the first plunger 21.

Further, since the tip of the first plunger 21 is tapered, even if an oxide film is formed on a surface of the connection electrode 101, by piercing through the oxide film, the tip is able to be contacted directly with the connection electrode 101. The tips of the first plunger and second plunger 22 may be modified as appropriate according to shapes of targets to be contacted therewith.

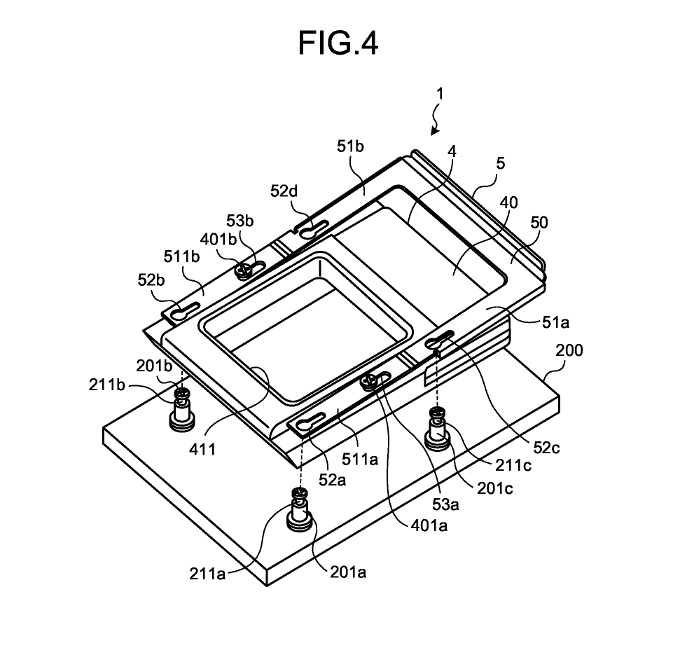

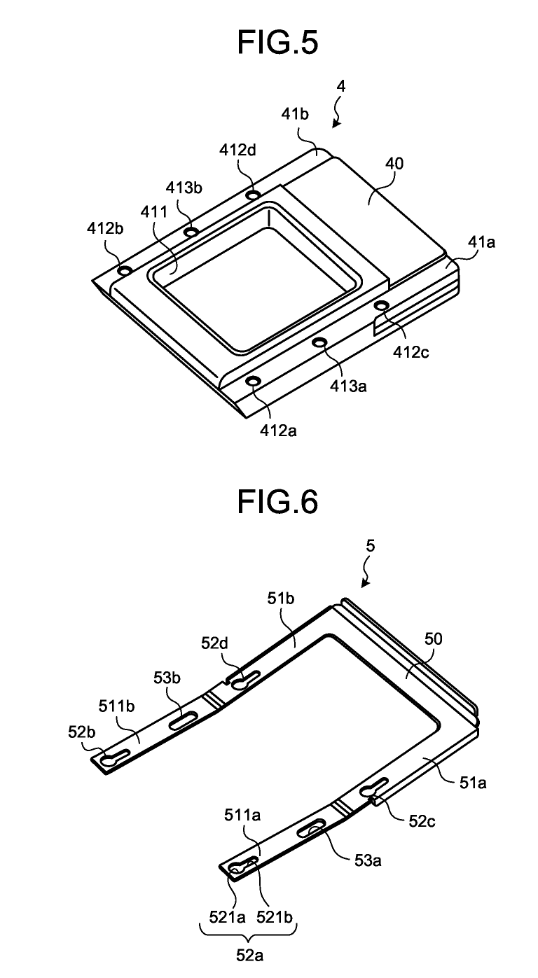

FIG. 4 is a perspective diagram illustrating a configuration of main parts of the socket according to the first embodiment. FIG. 5 is a perspective diagram illustrating a configuration of the holder member 4 of the socket attachment structure according to the first embodiment. The holder member 4 has a main body portion 40 that is formed by using a metal, such as a ferrous metal, a brass, or a stainless steel (SUS), or that is formed by using a synthetic resin material, a ceramic, or a material formed by insulating the metal. Further, in the main body portion 40, a fitting hole 411, in which the probe holder 3 is fittable, is provided. Furthermore, the main body portion 40 has notched portions 41a and 41b, which are respectively provided on opposite outer edge sides on a top surface side thereof, and which are notched along these outer edges. In the notched portions 41a and 41b, insertion holes 412a to 412d through which shafts 201a to 201d (support members, see FIG. 1 and FIG. 4) protruding from the circuit board 200 are respectively insertable, and screw holes 413a and 413b into which screws 401a and 401b for attaching the plate spring 5 are screwable, are formed.

FIG. 6 is a perspective diagram illustrating a configuration of the plate spring 5 of the socket attachment structure according to this first embodiment. The plate spring 5 has a base portion 50, which is formed by using a metallic material having spring properties and is approximately belt-shaped, and arm portions 51a and 51b, which respectively extend, from both longitudinal direction ends of the base portion 50, in a direction approximately perpendicular to a longitudinal direction of the base portion 50 on a plane that a plate surface thereof passes, and the plate spring 5 is approximately C-shaped in a planar view seen from a direction vertical to the plate surface. By central portions of the arm portions 51a and 51b being bent, the arm portions 51a and 51b have bending portions 511a and 511b, which are respectively provided on distal end sides thereof from positions of the bend and which are freely bendable with respect to the plate surface. Further, in the arm portions 51a and 51b, through holes 52a to 52d (first through holes) penetrating in a plate thickness direction are respectively formed correspondingly with the insertion holes 412a to 412d, and through holes 53a and 53b (second through holes) penetrating in the plate thickness direction are respectively formed correspondingly with the screw holes 413a and 413b. The through holes 52a and 52b are provided in the bending portions 511a and 511b, and the through holes 52c and 52d are formed in parts of the arm portions 51a and 51b other than the bending portions 511a and 511b.

The through hole 52a has a first hole portion 521a forming an approximately column shaped inner space, and a second hole portion 521b extending from the first hole portion 521a to a side different from the distal end side with a width less than a diameter of that column. The through holes 52b to 52d have a similar configuration (first hole portion 521a and second hole portion 521b).

The through holes 53a and 53b respectively form column shaped inner spaces extending in parallel with a direction in which the second hole portion 521b extends.

Lengths of the through holes 52a to 52d and through holes 53a and 53b in a longitudinal direction thereof are approximately the same. Further, positions in the through holes 52a to 52d and through holes 53a and 53b, the positions respectively communicating with the insertion holes 412a to 412d and screw holes 413a and 413b are relatively the same in the longitudinal direction thereof.

Further, the plate spring 5 is attached to the holder member 4 by the arm portions 51a and 51b being arranged on top surfaces of the notched portions 41a and 41b. Upon this attachment, in order to prevent the plate spring 5 from separating from the holder member 4, the screws 401a and 401b are attached thereto. The screws 401a and 401b are respectively screwed into the screw holes 413a and 413b via the through holes 53a and 53b (see FIG. 4).

In the circuit board 200, the shafts 201a to 201d, which extend in a vertical direction from a principal plane thereof, are provided (see FIG. 4). These shafts 201a to 201d have reduced diameter portions 211a to 211d (the reduced diameter portion 211d not being illustrated) having a reduced diameter on side surfaces at distal end sides thereof. The diameter of the insertion holes 412a to 412d and the first hole portion 521a are larger than a largest diameter of the shafts 201a to 201d. Further, the diameter of the second hole portion 521b is larger than the diameter of the reduced diameter portions 211a to 211d and less than the largest diameter of the shafts 201a to 201d.

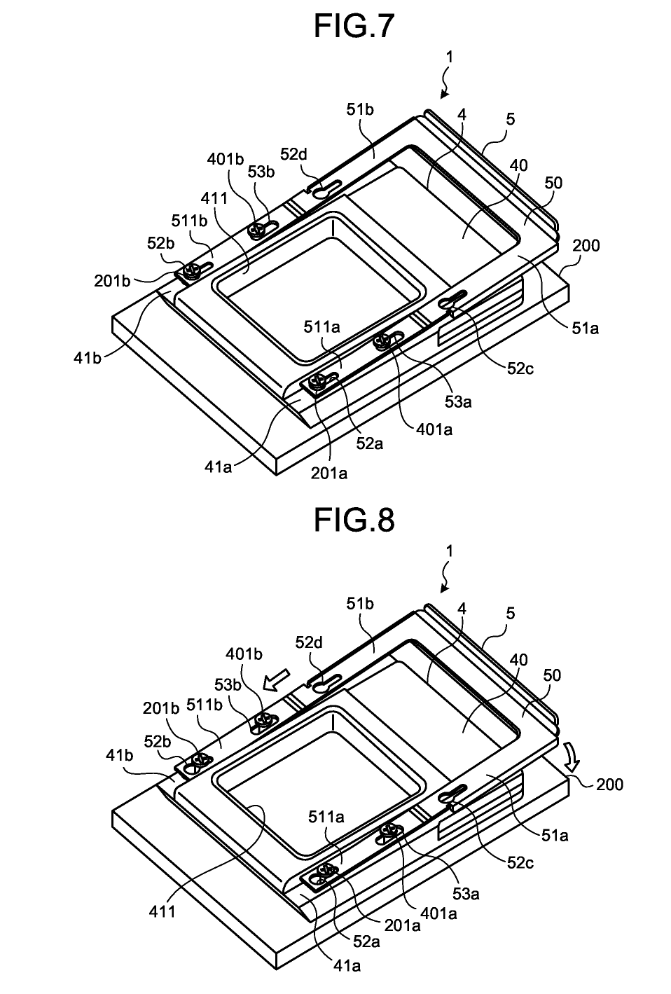

FIG. 7 to FIG. 9 are perspective diagrams illustrating a configuration of main parts of the socket according to this first embodiment and are diagrams illustrating a procedure for attaching the holder member 4 to the circuit board 200. First, attachment to the circuit board 200 is carried out in a state where the bending portions 511a and 511b of the plate spring 5 are in contact with the notched portions 41a and 41b, and the insertion holes 412a and 412b of the holder member 4 are respectively communicated with the first hole portions 521a of the through holes 52a and 52b. Upon this attachment, the shafts 201a to 201d are respectively penetrated through the insertion holes 412a to 412d and through holes 52a and 52b, and the holder member 4 and plate spring 5 are connected to the circuit board 200 (see FIG. 7). Further, the plate spring 5, excluding the bending portions 511a and 511b, is in a state of being slanted in a direction separating from a top surface of the main body portion 40.

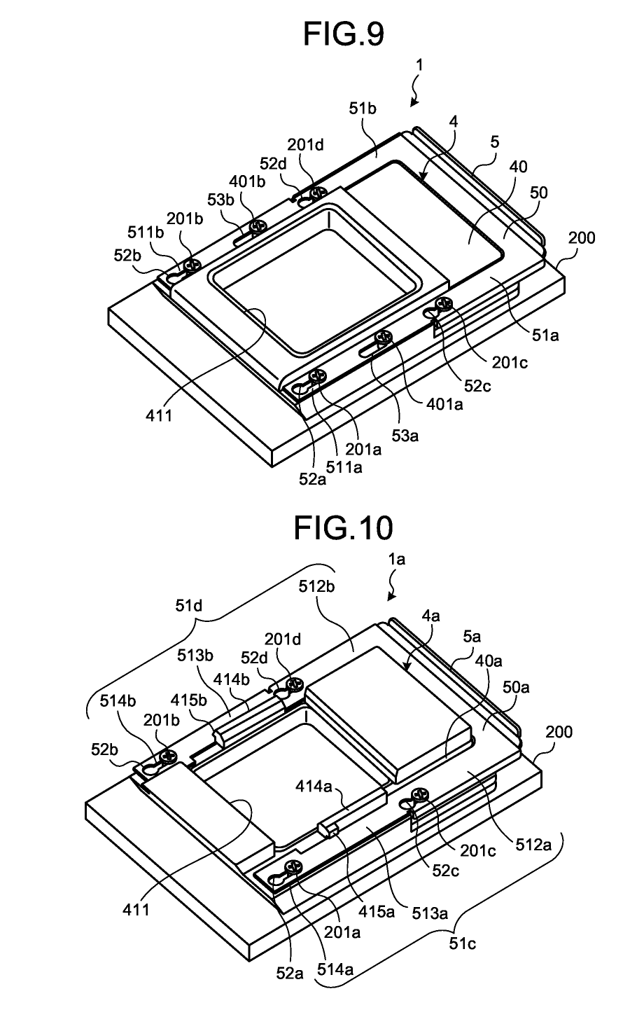

Thereafter, a load in a direction approaching the main body portion 40 is applied to the base portion 50 of the plate spring 5 and the arm portions 51a and 51b are slid along the direction in which the notched portions 41a and 41b extend (see FIG. 8). When this is done, by movement of the base portion 50 towards the main body portion 40, the plate spring 5 is brought into a state of biasing the holder member 4 towards the circuit board 200, and the shafts 201c and 201d are respectively inserted through the first hole portions 521a of the through holes 52c and 52d. Further, along with the sliding operation of the arm portions 51a and 51b, the shafts 201a to 201d penetrating through the first hole portions 521a move to the second hole portions 521b. This is a state where the reduced diameter portions 211a to 211d are inserted through the second hole portions 521b (see FIG. 9). As a result, the plate spring 5 is in a state of being fixed by the shafts 201a to 201d and the holder member 4 is able to be attached to the circuit board 200.

By the above described configuration and operations, just by sliding the plate spring 5 on the holder member 4 placed on the circuit board 200 while applying a load on the plate spring 5, the holder member 4 is able to be attached to the circuit board 200. Further, the plate spring 5 fixed on the holder member 4 by the shafts 201a to 201d biases the holder member 4 in the direction pressing the circuit board 200, by the elastic force due to the bending of the bending portions 511a and 511b, and thus the holder member 4 is able to be closely contacted with the circuit board 200.

Further, when the holder member 4 is removed from the circuit board 200, just by sliding the plate spring 5 in a direction reverse of the sliding direction upon the attachment, the holder member 4 is able to be removed from the circuit board 200.

According to the above described first embodiment, since the holder member 4 is attached to the circuit board 200 just by sliding the plate spring 5 attached on the holder member 4 while applying a load on the plate spring 5 and performing the latching onto the shafts, the holder member 4 is able to be detached and attached from and to the circuit board 200 easily.

When a holder member and a circuit board are fixed to each other by screwing as conventionally done, torque of the screws needs to be considered. In contrast, the socket attachment structure according to this first embodiment does not require screws when the holder member is fixed to the circuit board, and thus fixing is possible without the torque being considered.

Further, in the above described first embodiment, the shafts 201a to 201d on the circuit board 200 are able to be attached to the conventional screw holes for attachment with screws, and thus the attachment is able to be realized without providing holes dedicated thereto in the boards.

Although the reduced diameter portions 211a to 211d are provided in the shafts 201a to 201d according to the above description of the first embodiment, the diameter of only the distal ends of the shafts may be largely formed to be larger than the diameter of the second hole portions 521b.

Further, although the plate spring 5 is attached to the holder member 4 with the screws 401a and 401b according to the above description of the first embodiment, the plate spring 5 may be not attached to the holder member 4 in advance, and after arranging the holder member 4 on the circuit board 200, the plate spring 5 may be attached to the holder member 4 and thereafter screwed with the screws 401a and 401b.

### Second Embodiment

FIG. 10 to FIG. 12 are perspective diagrams illustrating a configuration of main parts of a socket (socket attachment structure) according to a second embodiment. To structural elements that are the same as those of the above described configurations, the same reference signs are appended. A socket 1a illustrated in FIG. 10 is a device used in testing electrical properties of the semiconductor integrated circuit 100 (see FIG. 1), which is a target to be tested (contacted body), and is a device that electrically connects between the semiconductor integrated circuit 100 and the circuit board 200, which outputs a test signal to the semiconductor integrated circuit 100. According to the above description of the first embodiment, the plate spring 5 is screwed onto the holder member 4 with the screws 401a and 401b, but in this second embodiment, a plate spring 5a is fixed to a holder member 4a with claw portions 415a and 415b provided in the holder member 4a.

The holder member 4a has a main body portion 40a that is formed by using a metal, such as a ferrous metal, a brass, or a stainless steel (SUS), or that is formed by using a synthetic resin material, a ceramic, or a material formed by insulating the metal. Further, in the main body portion 40a, the fitting hole 411, in which the probe holder 3 as described above is fittable, is provided. Further, in the main body portion 40a, as described above, the insertion holes 412a to 412d through which the shafts 201a to 201d protruding from the circuit board 200 are respectively insertable, and protruded portions 414a and 414b, which protrude from a principal plane of the main body portion 40a, which are connected to an inner wall surface of the fitting hole 411, and which come into contact with a part of the plate spring 5a (arm portions 51c and 51d) when the plate spring 5a is attached, are formed.

The protruded portions 414a and 414b extend from the principal plane of the main body portion 40a in an approximate rectangular column shape and ends of the protruded portions 414a and 414b on the fitting hole 411 side are chamfered. The distance between the protruded portions 414a and 414b may be designed such that by coming into contact with the plate spring 5a at side surfaces thereof, the protruded portions 414a and 414b guide the attachment direction.

The plate spring 5a has a base portion 50a, which is formed by using a metallic material having spring properties and is approximately belt-shaped, and arm portions 51c and 51d, which respectively extend, from both longitudinal direction ends of the base portion 50a, in a direction approximately perpendicular to a longitudinal direction of the base portion 50a on a plane that a plate surface thereof passes, and the plate spring 5a is approximately C-shaped in a planar view seen from a direction vertical to the plate surface.

The arm portion 51c has: a first arm portion 512a, which extends from one end of the base portion 50a in a belt shape in a direction orthogonal to the longitudinal direction of the base portion 50a; a second arm portion 513a, which extends slanted with respect to a principal plane of the first arm portion 512a and has a length in a width direction orthogonal to a longitudinal direction thereof, the length being shorter than a length of the first arm portion 512a in the width direction; and a third arm portion 514a, which extends from an end of the second arm portion 513a, the end being different from an end thereof connected to the first arm portion 512a, in the same direction in a belt shape, and has a length in the width direction that is approximately equivalent to that of the first arm portion 512a in the width direction. When viewed along the longitudinal direction thereof, the arm portion 51c forms a concave shape at a central portion thereof, and a principal plane of the second arm portion 513a and third arm portion 514a is bent with respect to the principal plane of the first arm portion 512a. The second arm portion 513a and third arm portion 514a form a bending portion.

The arm portion 51d has: a first arm portion 512b, which extends from one end of the base portion 50a in a belt shape in a direction orthogonal to the longitudinal direction of the base portion 50a; a second arm portion 513b, which extends slanted with respect to a principal plane of the first arm portion 512b and has a length in a width direction orthogonal to a longitudinal direction thereof, the length being shorter than a length of the first arm portion 512b in the width direction; and a third arm portion 514b, which extends from an end of the second arm portion 513b, the end being different from an end thereof connected to the first arm portion 512b, in the same direction in a belt shape, and has a length in the width direction that is approximately equivalent to that of the first arm portion 512b in the width direction. When viewed along the longitudinal direction thereof, the arm portion 51d forms a concave shape at a central portion thereof, and a principal plane of the second arm portion 513b and third arm portion 514b is bent with respect to the principal plane of the first arm portion 512b. The second arm portion 513b and third arm portion 514b form a bending portion.

In the first arm portions 512a and 512b, through holes 52a and 52c, which are provided correspondingly with the insertion holes 412a and 412c and penetrate in a plate thickness direction, are respectively formed. In the bending portions 511c and 511d, through holes 52b and 52d penetrating in the plate thickness direction are provided correspondingly with the insertion holes 412b and 412d. The through holes 52a to 52d are formed in the above described shape.

The second arm portions 513a and 513b are respectively formed in the arm portions 51c and 51d such that their concave shaped hollow spaces face each other. Further, an area in which the second arm portions 513a and 513b are formed in the longitudinal direction thereof is larger than an area in which the protruded portions 414a and 414b are formed in the longitudinal direction, considering a sliding distance upon attachment of the plate spring 5a to the holder member 4a.

The protruded portions 414a and 414b have the claw portions 415a and 415b, which are provided at parts of side surfaces of the protruded portions 414a and 414b, the side surfaces being opposite to the fitting hole 411 inner wall surface sides thereof, and protrude in directions orthogonal to these side surfaces. Further, a distance between the respective side surfaces opposite to the fitting hole 411 inner wall surface sides of the protruded portions 414a and 414b is approximately equal to a distance between the second arm portions 513a and 513b. A distance between bottoms of the claw portions 415a and 415b and the principal plane of the main body portion 40a is preferably approximately equivalent (equivalent or of a slightly larger distance) to a thickness of the plate spring 5a.

By the above described configuration, for the holder member 4a placed on the circuit board 200, just by accommodating the protruded portions 414a and 414b respectively in the concave shaped hollow space of the arm portions 51c and 51d (between stepped portions formed by the first arm portions 512a and 512b, as well as the bending portions 511c and 511d and the second arm portions 513a and 513b) and sliding the plate spring 5a along the guiding portions 414a and 414b while applying a load on the plate spring 5a, the holder member 4a is able to be attached to the circuit board 200. When this is done, in a state where the plate spring 5a is biased in a direction pressing the circuit board 200 by the bending of the bending portions 511c and 511c, the second arm portions 513a and 513b are brought into a state of being fixed to the holder member 4a by being locked by the claw portions 415a and 415b. As a result, the plate spring 5a is able to be prevented from separating from the holder member 4a and the biased state of the plate spring 5a with respect to the holder member 4a is able to be maintained more reliably. Further, with this bias by the plate spring 5a, the holder member 4a is able to be closely contacted with the circuit board 200.

Further, when the holder member 4a is removed from the circuit board 200, just by sliding the plate spring 5a in a direction reverse of the sliding direction upon the attachment, the holder member 4a is able to be removed from the circuit board 200.

According to the second embodiment, the above described effects of the first embodiment are able to be obtained, and further, even if the width (the length in the direction orthogonal to the longitudinal direction) of the arm portions 51c and 51d of the plate spring 5a is smaller than the screw holes and formation of the screw holes is difficult, without forming the screw holes, the plate spring 5a is able to be fixed to the holder member 4a. Further, since screwing is not necessary, the plate spring 5a is able to be fixed to the holder member 4a even more easily.

If the distance between the bottoms of the claw portions 415a and 415b and the principal plane of the main body portion 40a is approximately equivalent to the thickness of the plate spring 5a, the plate spring 5a is brought into a state of being fitted in between the claw portions 415a and 415b and the main body portion 40a and being fixed to the holder member 4a, and thus the fixed state is able to be maintained even more stably.

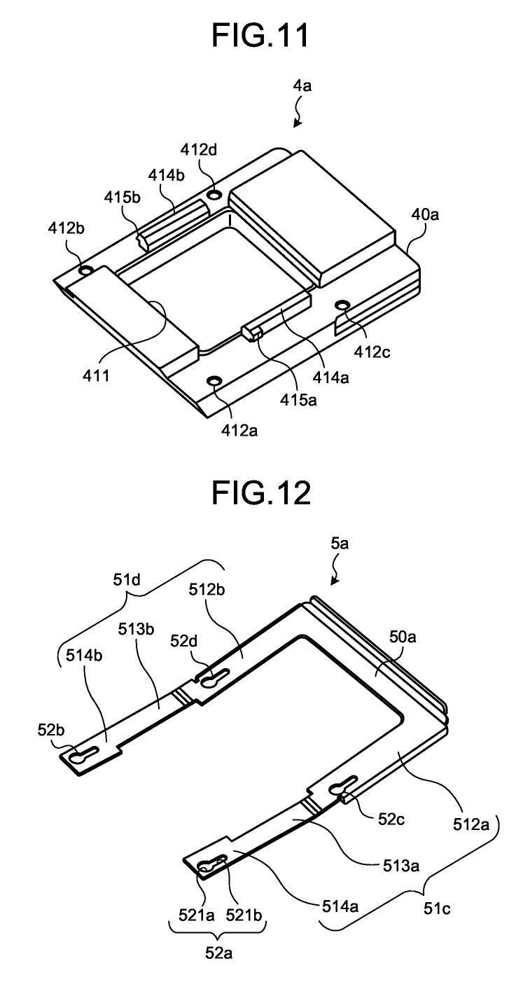

Further, as illustrated in FIG. 10 and FIG. 11, the main body portion 40a of the holder member 4a may be in a stepped shape to roughly guide the attachment direction of the plate spring 5a. Like in the above described first embodiment, the main body portion 40a of the holder member 4a may have notched portions to guide the attachment direction of the plate spring 5a.

Further, the arm portions 51c and 51d have been described as forming concave shapes at the central portions thereof when viewed along the longitudinal direction, but as long as locking with the claw portions 415a and 415b is possible, the length of the second arm portions 513a and 513b in the width direction may be identical to the length of the first arm portions 512a and 512b in the width direction such that belt shapes are formed with the length of the arm portions in the width direction being uniform when viewed along the longitudinal direction.

### Third Embodiment

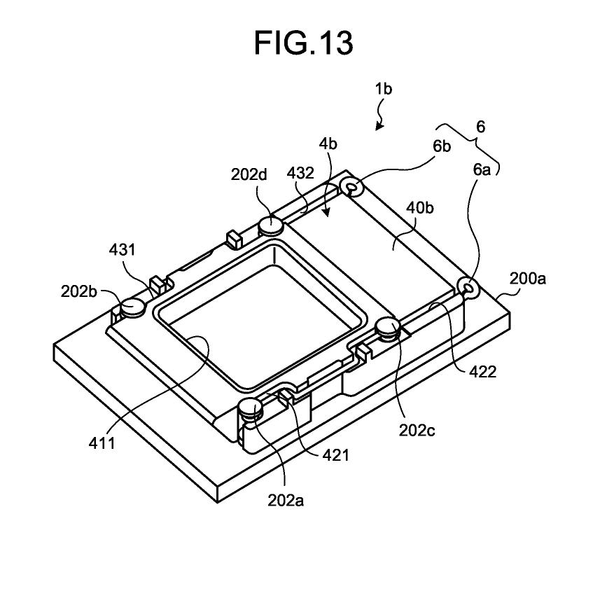

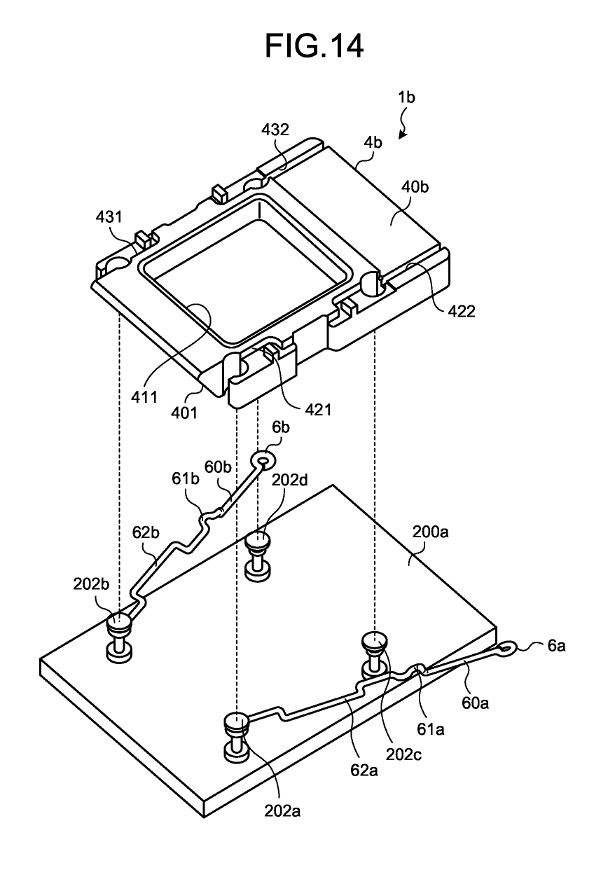

FIG. 13 is a perspective diagram illustrating a configuration of main parts of a socket according to a third embodiment. FIG. 14 is an exploded perspective diagram illustrating a configuration of main parts of the socket according to the third embodiment. In the diagrams, illustration of the probe and the probe holder is omitted. Similarly to the above described first embodiment, a socket 1b illustrated in FIG. 13 and FIG. 14 is a device used in testing electrical properties of the semiconductor integrated circuit 100 (see FIG. 1), and is a device that electrically connects between the semiconductor integrated circuit 100 and a circuit board 200a, which outputs a test signal to the semiconductor integrated circuit 100.

The socket 1b has: a holder member 4b (holder member), which has the above described probes 2 and probe holder, is provided around the probe holder, and suppresses displacement of a semiconductor integrated circuit that comes into contact with the plurality of probes when tested; and a spring member 6, which is attached to a top surface of the holder member 4b and biases the holder member 4b towards the circuit board 200a.

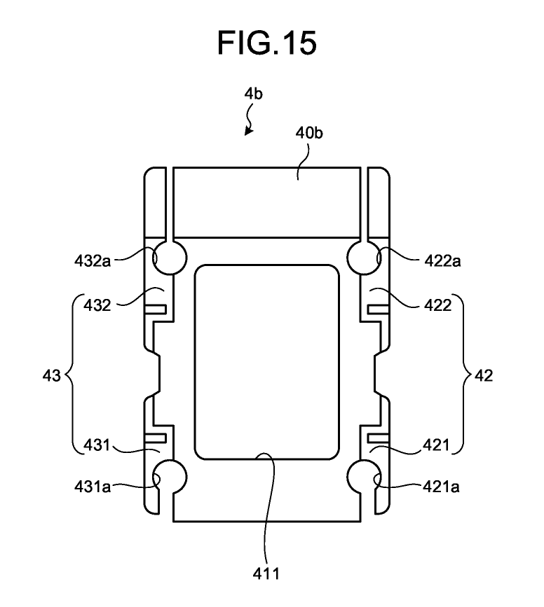

FIG. 15 is a plan view illustrating a configuration of the holder member 4a of a socket attachment structure according to the third embodiment. The holder member 4b has a main body portion 40b that is formed by using a metal, such as a ferrous metal, a brass, or a stainless steel (SUS), or formed by using a synthetic resin material, a ceramic, or a material formed by insulating the metal. Further, in the main body portion 40b, a sloped portion 401 having a sloped side surface at one end of the main body portion 40b, and the fitting hole 411, in which the above described probe holder 3 is fittable, are provided. Furthermore, the main body portion 40b has notched portions 42 and 43, which are respectively provided on opposite outer edge sides on a top surface side thereof, and notched along these outer edges.

The notched portion 42 has: a first notched portion 421, which is notched to extend along one of the outer edges of the main body portion 40b (one side of the rectangle), forms a stepped shape such that a distance thereof from the outer edge is decreased at an extending direction end thereof, extends from one end of this outer edge, and has a distance (depth) in a plate thickness direction, the distance having a depth larger than a diameter of the spring member 6; and a second notched portion 422, which is also notched to extend along the one of the outer edges of the main body portion 40b (one side of the rectangle), forms the stepped shape such that the distance thereof from the outer edge is decreased at the extending direction end thereof, extends from the other end of this outer edge and has a depth larger than the diameter of the spring member 6. Further, in the first notched portion 421 and second notched portion 422, insertion holes 421a and 422a, through which later described shafts 202a and 202c are respectively insertable, are provided.

The notched portion 43 has: a first notched portion 431, which is notched to extend along an outer edge of the main body portion 40b, the outer edge being opposite to the notched portion 42, forms a stepped shape such that a distance thereof from the outer edge is decreased at an extending direction end thereof, extends from one end of this outer edge, and has a distance (depth) in the plate thickness direction, the distance having a depth larger than the diameter of the spring member 6; and a second notched portion 432, which is also notched to extend along the outer edge of the main body portion 40b, the outer edge being opposite to the notched portion 42, forms the stepped shape such that the distance thereof from the outer edge is decreased at the extending direction end thereof, extends from the other end of this outer edge and has a depth larger than the diameter of the spring member 6. Further, in the first notched portion 431 and second notched portion 432, insertion holes 431a and 432a, through which later described shafts 202b and 202d are respectively insertable, are provided.

The spring member 6 has torsion bars 6a and 6b (bar-shaped members), which are formed by using a metallic material having spring properties and are provided correspondingly with the notched portions 42 and 43. The torsion bar 6a has: a base portion 60a, which is approximately bar-shaped, and is wound around at both ends thereof; a convex portion 61a, which is provided at one end side of the base portion 60a and curved in a convex shape; and a bent portion 62a, which is provided at the other end side of the base portion 60a and is bent in a C-shape. The torsion bar 6b has, similarly to the torsion bar 6a: a base portion 60b, which is approximately bar-shaped, and is wound around at both ends thereof; a convex portion 61b, which is provided at one end side of the base portion 60b and curved in a convex shape; and a bent portion 62b, which is provided at the other end side of the base portion 60b and is bent in a C-shape.

On the circuit board 200a, the shafts 202a to 202d, which extend in a vertical direction from the principal plane, are provided (see FIG. 14). In these shafts 202a to 202d, a diameter of a side surface at a proximal end side thereof is reduced as compared with a diameter of a side surface at a distal end side thereof. Around the reduced diameter portions of the shafts 202a and 202b, end portions of the torsion bars 6a and 6b at the bent portions 62a and 62b side are wound (see FIG. 15). The torsion bars 6a and 6b are rotatable about the shafts 202a and 202b being the axes. The end portions of the torsion bars 6a and 6b are prevented from coming off by the enlarged diameters of distal end portions of the shafts 202a and 202b. Further, electrodes, which are not illustrated, are provided in the circuit board 200a.

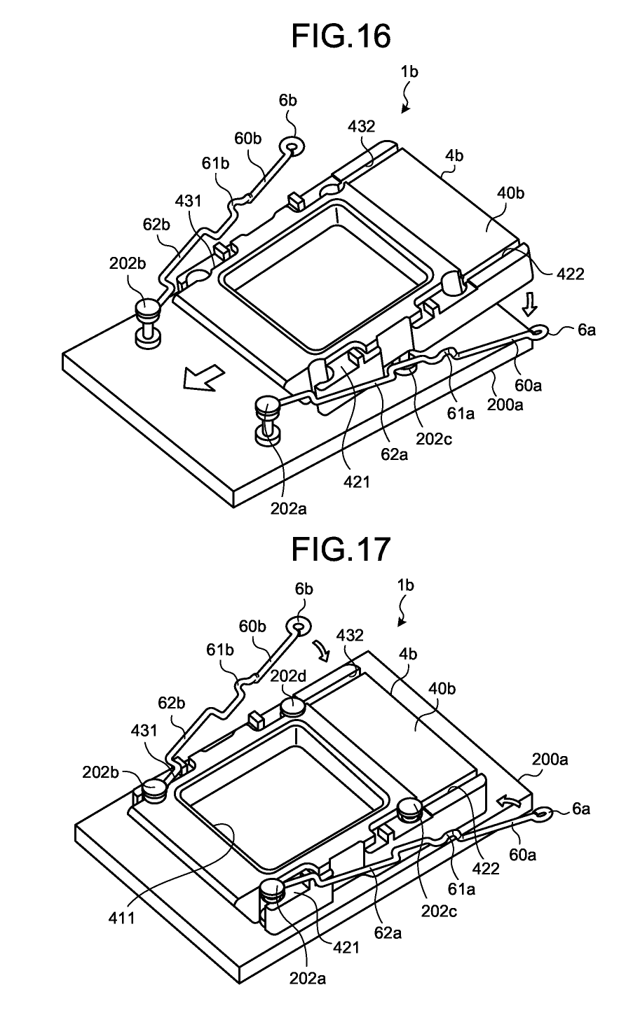

FIG. 16 and FIG. 17 are perspective diagrams illustrating a configuration of main parts of the socket according to this third embodiment and are diagrams illustrating a procedure for attaching the holder member 4b to the circuit board 200a. First, the holder member 4b is attached to the circuit board 200a. When that is done, the sloped portion 401 of the holder member 4b is slid with respect to the circuit board 200a to insert the shafts 202a and 202b respectively through the insertion holes 421a and 431a of the first notched portions 421 and 431 (see FIG. 16). Thereafter, an end portion of the holder member 4b at a side opposite to the sloped portion 401 side is pressed towards the circuit board 200a to insert the shafts 202c and 202d respectively through the insertion holes 422a and 432a of the second notched portions 422 and 432 (see FIG. 17). As a result, positioning of the holder member 4a with respect to the circuit board 200a in a plane direction is achieved.

After the insertion of the shafts 202a to 202d, a load is applied, in a direction of bringing end portions of the torsion bars 6a and 6b at a side opposite to the portions coupled to the shafts closer to the main body portion 40b (see FIG. 17). When this is done, the convex portions 61a and 61b of the torsion bars 6a and 6b are respectively latched onto the shafts 202c and 202d. Further, the bent portions 62a and 62b of the torsion bars 6a and 6b are respectively fitted with inner surfaces of the notched portions 42 and 43, the inner surfaces forming convex shapes (see FIG. 13). When that is done, the torsion bars 6a and 6b bias the holder member 4b towards the circuit board 200a by their own spring actions. As a result, the holder member 4b is able to be brought into a state of being sandwiched and fixed between the circuit board 200a (shafts 202a to 202d) and the spring member 6, and the holder member 4a is able to be attached to the circuit board 200a.

By the above described configuration and operations, with respect to the holder member 4b placed on the circuit board 200a, just by applying a load on the spring member 6 and latching the spring member 6 onto the shafts, the holder member 4b is able to be attached to the circuit board 200a. Further, the spring member 6 fixed on the holder member 4b by the shafts 202a to 202d biases the holder member 4b in a direction of pressing the circuit board 200a by its own elastic force, and thus the holder member 4b is able to be closely contacted with the circuit board 200a.

Further, when the holder member 4b is removed from the circuit board 200a, just by removing the spring member 6 latched onto the shafts 202c and 202d, the holder member 4b is able to be removed from the circuit board 200a.

According to the above described third embodiment, just by applying a load on the spring member 6 attached to the holder member 4b and latching the spring member 6 onto the shafts, the holder member 4b is attached to the circuit board 200a, and thus the holder member 4b is able to be removed from and attached to the circuit board 200a easily.

Further, if a holder member and a circuit board are fixed to each other by screwing as conventionally done, torque of the screws needs to be considered. In contrast, the socket attachment structure according to this third embodiment does not require screws when the holder member is fixed to the circuit board, and thus fixing is possible without the torque being considered.

Further, according to the above description of the third embodiment, the spring member 6 (torsion bars 6a and 6b) is coupled to the shafts, but this coupling may be not performed in advance, and after arranging the holder member 4b on the circuit board 200a, the attachment therebetween may be performed.

According to the above description of the first to third embodiments, the connection electrode 101 is hemispherical, but the connection electrode 101 may be a flat plate shaped lead used in a quad flat package (QFP) or the like.

Further, as long as the holder member and the circuit board 200 are able to be fixed to each other by the spring member (plate spring 5 or 5a, or spring member 6) and the shafts, a configuration not having notched portions may be used.

The probe 2 is not limited to the one configured of the plungers and the pipe member as illustrated in FIG. 2, and may be a wire probe having a wire that is warped in an arch to obtain a load.

Further, according to the above description of the first to third embodiments, the probe holder and the holder member are separately provided, but they may be integrally formed, or a probe holder, as a unit, may have the above described configuration of the holder member.

### INDUSTRIAL APPLICABILITY

As described above, a socket attachment structure and a spring member according to the present invention are useful for detaching and attaching a holder member from and to a circuit board easily.

### REFERENCE SIGNS LIST

1, 1a, 1b Socket
2 Contact probe (probe)
3 Probe holder
4, 4a, 4b Holder member
5, 5a Plate spring
6 Spring member
6a, 6b Torsion bar
21 First plunger
22 Second plunger
23 Pipe member
31 First member
32 Second member
33, 34 Holder hole
33a, 34a Small diameter portion
33a, 34a Large diameter portion
40, 40a, 40b Main body portion
41a, 41b, 42, 43 Notched portion
50, 60a, 60b Base portion
51a, 51b, 51c, 51d Arm portion
52a to 52d, 53a, 53b Through hole
61a, 61b Convex portion
62a, 62b Bent portion
100 Semiconductor integrated circuit
101 Connection electrode
200, 200a Circuit board
201 Electrode
201a to 201d, 202a to 202d Shaft
211a to 211d Reduced diameter portion
401a, 401b Screw
411 Fitting hole
412a to 412d, 421a, 422a, 431a, 432a Insertion hole
413a, 413b Screw hole
414a, 414b Protruded portion
415a, 415b Claw portion
421,431 First notched portion
422, 432 Second notched portion
511a, 511b Bending portion
512a, 512b First arm portion
513a, 513b Second arm portion
514a, 514b Third arm portion
521a First hole portion
521b Second hole portion

1. A socket attachment structure for attaching a socket to a substrate, the socket including a plurality of contact probes that respectively contact the substrate and a contacted body at both longitudinal direction ends thereof, a probe holder that accommodates and holds therein the plurality of contact probes according to a predetermined pattern, and a holder member provided around the probe holder, the socket attachment structure comprising:
a plurality of support members that extend out from a principal plane of the substrate and are respectively inserted through insertion holes provided in the holder member; and
a spring member that is attached to the plurality of support members in a state of biasing the holder member placed on the substrate towards the substrate.

2. The socket attachment structure according to claim 1, wherein
the spring member is a plate spring, has a base portion that is approximately belt shaped, and two arm portions that extend from both longitudinal direction ends of the base portion on a plane that a plate surface passes, in a direction approximately perpendicular to a longitudinal direction of the base portion, and forms an approximate C-shape in a planar view seen from a direction vertical to the plate surface, and
the arm portion comprises:
a bending portion that is provided at a distal end side and bends with respect to the plate surface; and
a first through hole that penetrates in a plate thickness direction and through which the support member is insertable.

3. The socket attachment structure according to claim 2, wherein
the support member has a reduced diameter at a side surface at a distal end side thereof,
the first through hole comprises:
a first hole portion that forms an inner space having a diameter larger than a largest diameter of the support member and that is approximately column shaped; and
a second hole portion that extends to a side different from a distal end side with a width less than the diameter of the first hole portion and larger than a portion of the support member with the reduced diameter, and
after the support members are inserted through the first hole portions, the plate spring is slid with respect to the substrate and the second hole portions are latched onto the support members.

4. The socket attachment structure according to claim 3, wherein
the holder member comprises a screw hole that is screwable,
the arm portion comprises a second through hole penetrating in the plate thickness direction correspondingly with the screw hole, and
the holder member and the spring member are coupled to each other via the screw hole and the second through hole.

5. The socket attachment structure according to claim 3, wherein
the holder member comprises:
a protruded portion that protrudes from a principal plane in an approximate column shape and comes into contact with a part of the arm portion; and
a claw portion that protrudes from a part of a side surface of the protruded portion, and
the holder member and the spring member are fixed to each other by the arm portion being latched onto the claw portion.

6. The socket attachment structure according to claim 1, wherein
the spring member is a plurality of bar shaped members that are elastically deformable,
the spring member comprises:
a base portion that is approximately bar shaped; and
a convex portion that is provided at one end side of the base portion and curved in a convex shape, and
the convex portion is latched onto one of the support members and the other end side of the base portion is coupled to another one of the support members.

7. The socket attachment structure according to claim 6, wherein the other end side of the base portion is wound around the support member and the spring member is rotatable about the support member being a central axis.

8. The socket attachment structure according to claim 1, wherein
the holder member comprises two notched portions that are respectively provided at opposite outer edge sides on a top surface side thereof and that are notched along these outer edges, and
the holder member guides an attachment position of the spring member with respect to the holder member.

9. A spring member for being used in order to attach a socket to a substrate, the socket including: a plurality of contact probes that respectively contact the substrate and a contacted body at both longitudinal direction ends thereof; a probe holder that accommodates and holds therein the plurality of contact probes according to a predetermined pattern; and a holder member provided around the probe holder, wherein
the spring member is attached to a plurality of support members in a state of biasing the holder member placed on the substrate towards the substrate, the plurality of support members extending out from a principal plane of the substrate, and the plurality of support members being respectively inserted through insertion holes provided in the holder member.
